(19) United States
(12) Patent Application Publication
(10) Pub. No.: US 2014/0047483 A1
(43) Pub. Date: Feb. 13, 2014

(54) System and Method for Providing Additional Information Associated with an Object Visually Present in Media

(71) Applicant: Neal Fairbanks, Livonia, MI (US)

(72) Inventor: Neal Fairbanks, Livonia, MI (US)

(21) Appl. No.: 13/925,168

(22) Filed: Jun. 24, 2013

Related U.S. Application Data
(60) Provisional application No. 61/680,897, filed on Aug. 8, 2012.

(51) Int. Cl. H04N 21/478

(52) U.S. Cl. CPC H04N 21/478
USPC 725/60

(57) ABSTRACT

A computer-implemented system and method for providing additional information associated with an object visually present in media content in response to selection of the object in the media content by a user is provided. Object parameters are established in association with the object. The object parameters are stored in a database. The additional information is linked to the object parameters. Selection event parameters are received in response to a selection event by the user selecting the object in the media content during playback of the media content. The selection event parameters are compared to the object parameters in the database. The method determines whether the selection event parameters are within the object parameters. The additional information is retrieved if the selection event parameters are within the object parameters such that the additional information is displayable to the user without interfering with playback of the media content.

### CROSS-REFERENCES TO RELATED APPLICATIONS

This application claims priority to U.S. Provisional Patent Application No. 61/680,897, filed Aug. 8, 2012.

### BACKGROUND OF THE INVENTION

1. Field of the Invention

The invention generally relates to a system and method for enabling an object in media content to be interactive, and more specifically for providing additional information associated with an object visually present in media content in response to selection of the object in the media content by a user.

2. Description of the Related Art

Media content, such as television media content, is typically broadcasted by a content provider to an end-user. Embedded within the media content are a plurality of objects. The objects traditionally are segments of the media content that are visible during playback of the media content. As an example, without being limited thereto, the object may be an article of clothing or a household object displayed during playback of the media content. It is desirable to provide additional information, such as advertising information, in association with the object in response to selection or “clicking” of the object in the media content by the end-user.

There have been prior attempts to provide such interactivity to objects in media content. Prior attempts traditionally require physical manipulation of the object or the media content. For example, some prior methods require the media content to be edited frame-by-frame to add interactivity to the object. Moreover, frame-by-frame editing often requires manipulation of the actual media content itself. But, manipulating the media content itself is largely undesirable. One issue presented in creating these interactive objects is interleaving it with the media stream. Faced with this issue, the prior art discloses transmitting the interactive objects in video blanking intervals (VBI) associated with the media content. In other words, if the video is being transmitted at 30 frames per second (a half hour media content contains over 100,000 frames), only about 22 frames actually contain the media content. This leaves frames that are considered blank and one or two of these individual frames receives the interactive object data. Since the frames are passing at such a rate, the user or viewer upon seeing the hot spot and wishing to select it, will select it for a long enough period of time such that a blank frame having the hot spot data will pass during this period. Other prior art discloses editing only selected frames of the media stream, instead of editing each of the individual frames. However, even if two frames per second were edited, for a half-hour media stream, 3,600 frames would have to be edited. This would take considerable time and effort even for a most skilled editor.

Another prior attempt entails disposing over the media content a layer having a physical region that tracks the object in the media content during playback and detecting a click within the physical region. This method overlays the physical regions in the media content. Mainly, the layer had to be attached to the media content to provide additional “front-end” processing. Thus, this prior attempt could not instantaneously provide the additional information to the end-user unless the physical region was positioned in a layer over the object.

Accordingly, it would be advantageous to provide a system and a method that overcomes the prior art.

### SUMMARY OF THE INVENTION

The subject invention provides a computer-implemented method for providing additional information associated with an object visually present in media content in response to selection of the object in the media content by a user. The method includes the step of establishing object parameters comprising user-defined time and user-defined positional data associated with the object. The object parameters are stored in a database. The object parameters are linked with the additional information. Selection event parameters are received in response to a selection event by the user selecting the object in the media content during playback of the media content. The selection event parameters include selection time and selection positional data corresponding to the selection event. The selection event parameters are compared to the object parameters in the database. The method includes the step of determining whether the selection event parameters are within the object parameters. The additional information is retrieved if the selection event parameters are within the object parameters such that the additional information is displayable to the user without interfering with playback of the media content.

Accordingly, the method advantageously provides interactivity to the object in the media content to allow the user to see additional information such as advertisements in response to clicking the object in the media content. The method beneficially requires no frame-by-frame editing of the media content to add interactivity to the object. As such, the method provides a highly efficient way to provide the additional information in response to the user's selection of the object. Furthermore, the method does not require a layer having a physical region that tracks the object in the media content during playback. Instead, the method establishes and analyzes object parameters in the database upon the occurrence of the selection event. The method is able to take advantage of the computer processing power to advantageously provide interactivity to the object through a “back-end” approach that is advantageously hidden from the media content and user viewing the media content. Additionally, the method efficiently processes the selection event parameters and does not require continuous synchronization of between the object parameters in the database and the media content. In other words, the method advantageously references the object parameters in the database when needed, thereby minimizing adverse performance on the user device, the player, and the media content.

### BRIEF DESCRIPTION OF THE DRAWINGS

Advantages of the present invention will be readily appreciated, as the same becomes better understood by reference to the following detailed description when considered in connection with the accompanying drawings.

FIG. 1 is an illustrative system for providing additional information associated with an object visually present in media content in response to selection of the object in the media content by a user in according to one embodiment;

FIG. 2 is an illustration of an editor according to one embodiment which enables a region to be defined temporarily in relation to the object such that object parameters associated with the object can be established and stored in a database;

FIG. 3 is an illustration of a player according to one embodiment whereby the additional information is displayed to the user if selection event parameters corresponding to the user's selection of the object are within the object parameters; and

FIG. 4 is a flow chart representing the method for providing additional information associated with the object visually present in media content in response to selection of the object in the media content by the user according to one embodiment.

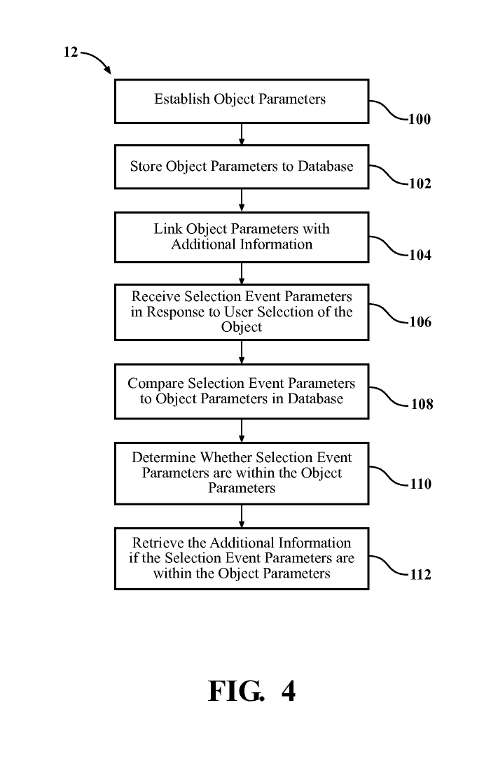

### DETAILED DESCRIPTION OF THE PREFERRED EMBODIMENT

Referring to the Figures, wherein like numerals indicate corresponding parts throughout the several views, a system 10 and a method 12 for providing additional information 14 associated with an object 16 in response to selection of the object 16 in media content 18 by a user 20, are shown generally throughout the Figures.

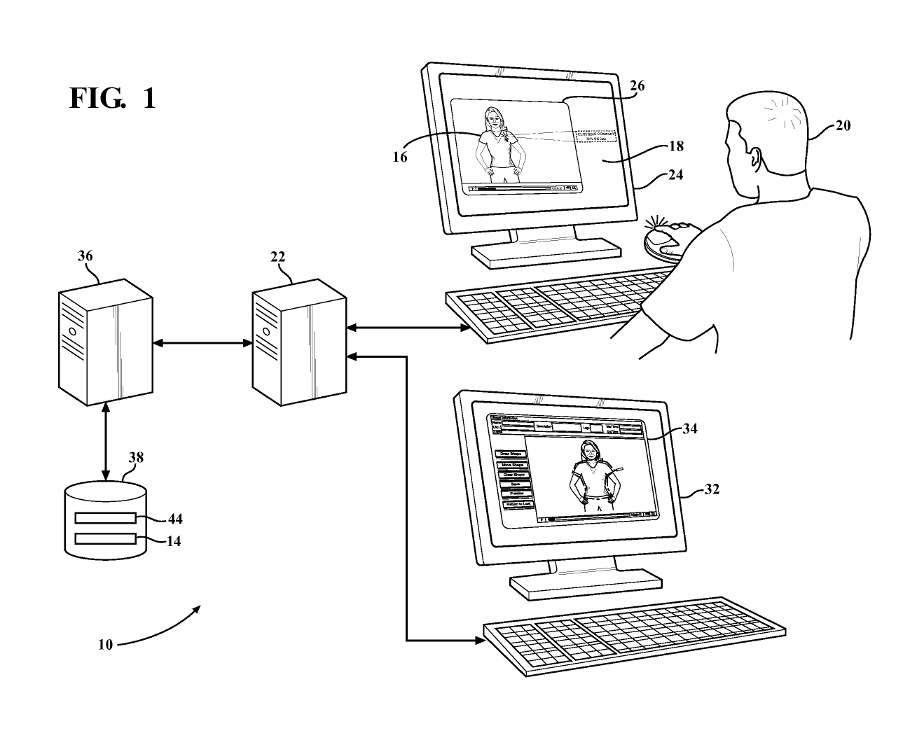

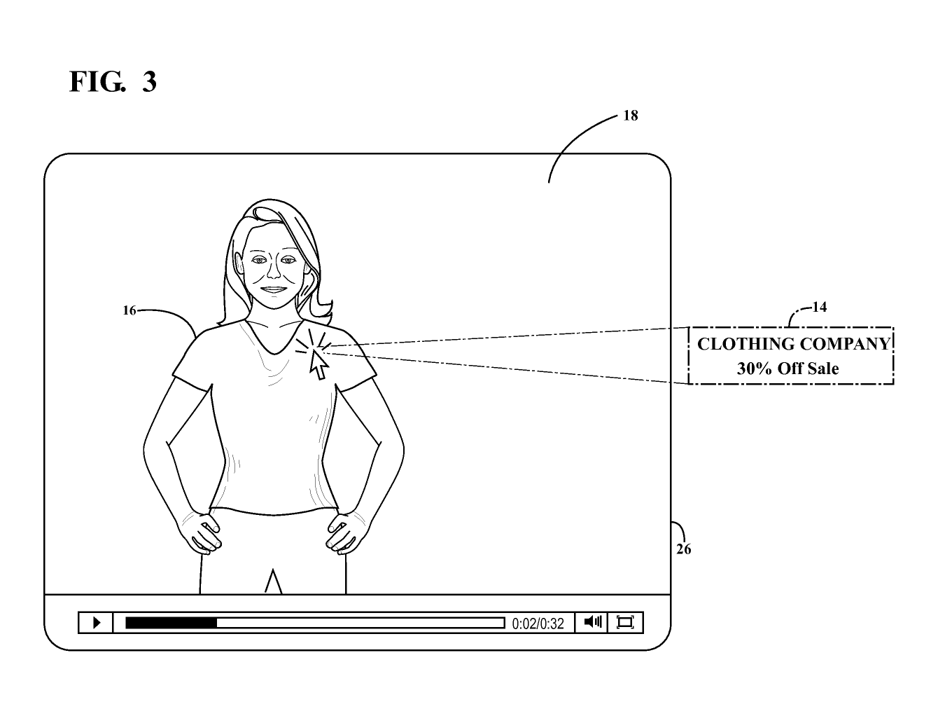

As shown in FIGS. 1 and 3, the user 20 is presented with the media content 18. A content provider typically broadcasts or transmits the media content 18 to the user 20. Examples of the media content 18 include, but are not limited to, recorded or live television programs, movies, sporting events, news broadcasts, and streaming videos.

Transmission of the media content 18 by the content provider may be accomplished by satellite, network, internet, or the like. In one example as shown in FIG. 1, the content provider provides the media content 18 to the user 20 through a web server 22. The system 10 includes a user device 24 for receiving the media content 18 from the web server 22. The user 20 may receive the media content 18 in various types of user devices 24 such as digital cable boxes, satellite receivers, smart phones, laptop or desktop computers, tablets, televisions, and the like. In one example as shown in FIG. 1, the user device 24 is a computer that is in communication with the web server 22 for receiving the media content 18 from the web server 22.

The media content 18 may be streamed such that the media content 18 is continuously received by and presented to the user 20 while being continuously delivered by the content provider. The media content 18 may be transmitted in digital form. Alternatively, the media content 18 may be transmitted in analog form and subsequently digitized.

The system 10 further includes a player 26 for playing the media content 18. The player 26 may be integrated into the user device 24 for playing the media content 18 such that the media content 18 is viewable to the user 20. Examples of the player 26 include, but are not limited to, Adobe Flash Player or Windows Media Player, and the like. The media content 18 may be viewed by the user 20 on a visual display, such as a screen or monitor, which may be connected or integrated with the user device 24. As will be described below, the user 20 is able to select the object 16 in the media content 18 through the user device 24 and/or the player 26.

The object 16 is visually present in the media content 18. The object 16 may be defined as any logical item in the media content 18 that is identifiable by the user 20. In one embodiment, the object 16 is a specific item in any segment of the media content 18. For example, within the 30-second video commercial, the object 16 may be a food item, a corporate logo, or a vehicle, which is displayed during the commercial. For simplicity, the object 16 is illustrated as a clothing item throughout the Figures. The object 16 includes attributes including media-defined time and media-defined positional data corresponding to the presence of the object 16 in the media content 18.

As illustrated in FIG. 1, an editing device 32 is connected to the web server 22. In one example, the editing device 32 is a computer such as a desktop computer, or the like. However, the editing device 32 may include any other suitable device. An authoring tool 34 is in communication with the editing device 32. In one embodiment, the authoring tool 34 is a software program that is integrated in the editing device 32. A media server 36 is in communication with the web server 22. In other words, the media server 36 sends and receives signal or information to and from the web server 22. A database 38 is in communication with the media server 36. In other words, the database 38 sends and receives signal or information to and from the media server 36. However, other configurations of the system 10 are possible without departing from the scope of the invention.

The media content 18 is provided to the editing device 32. The media content 18 may be provided from the web server 22, the media server 36, or any other source. In one embodiment, the media content 18 is stored in the media server 36 and/or the database 38 after being provided to the editing device 32. In another embodiment, the media content 18 is downloaded to the editing device 32 such that the media content 18 is stored to the editing device 32 itself. In some instances, an encoding engine may encode or reformat the media content 18 to one standardized media type which is cross-platform compatible. As such, the method 12 may be implemented without requiring a specialized player 26 for each different platform.

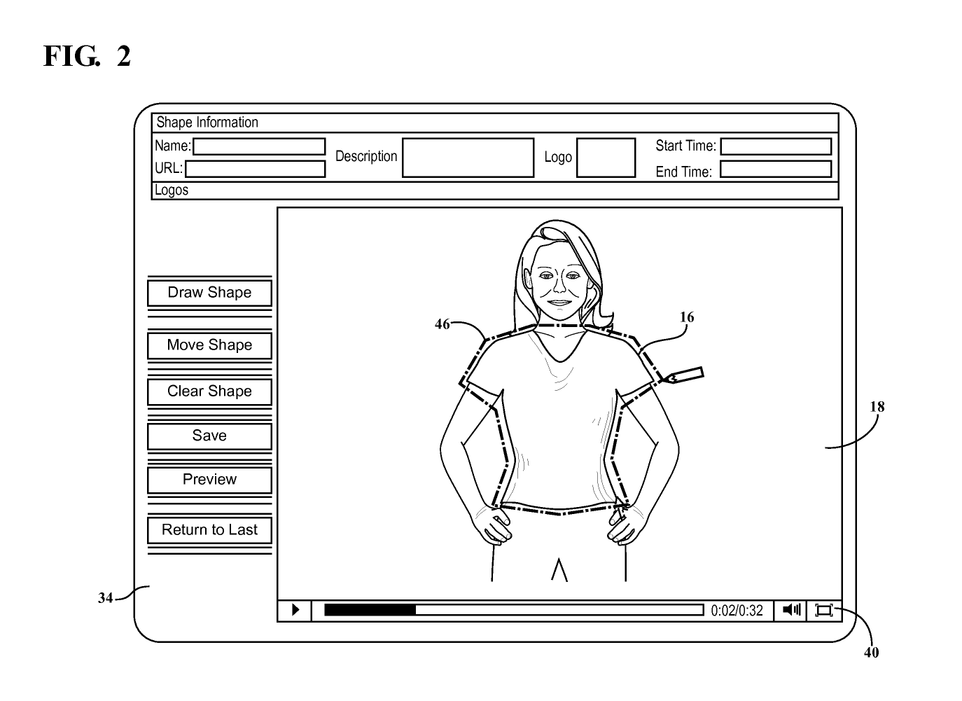

As shown in FIG. 2, the media content 18 is accessed by the authoring tool 34 from the editing device 32. With the authoring tool 34, the media content 18 is displayed in an authoring tool player 40. Here, a user of the editing device 32 can examine the media content 18 to determine which object 16 to associate the additional information 14.

The method 12 includes the step 100 of establishing object parameters 44 associated with the object 16. The object parameters 44 include user-defined time and user-defined positional data associated with the object 16. The user of the editing device 32 utilizes the authoring tool 34 to establish the object parameters 44. It is to be appreciated that “user-defined” refers to the user of the editing device 32 that creates the object parameters 44. According to one embodiment, as shown in FIG. 2, the object parameters 44 are established by defining a region 46 in relation to the object 16. The authoring tool 34 enables the user of the editing device 32 to draw, move, save and preview the region 46 drawn in relation to the object 16. The region 46 is defined generally in relation to the attributes of the object in the media, e.g., media-defined time and media-defined position of the object 16. The region 46 may be drawn with the authoring tool 34 in relation to any given position and time the object 16 is present in the media content 18. For example, as illustrated in FIG. 2, the region 46 is drawn in relation to the object 16 shown as a clothing item that is visibly present in the media content 18 at a given time. The authoring tool player 40 enables the user of the editing device 32 to quickly scroll through the media content 18 to identify when and where a region 46 may be drawn in relation to the object 16.

The region 46 may be drawn in various ways. In one embodiment, the region 46 is drawn to completely surround the object 16. For example, in FIG. 2, the region 46 surrounds the clothing item. The region 46 does not need to correspond completely with the object 16. In other words, the region 46 may surround the object 16 with excess space between an edge of the object 16 and the edge of the region 46. Alternatively, the region 46 may be drawn only in relation to parts of the object 16. A plurality of regions 46 may also be drawn. In one example, the plurality of regions 46 are drawn for various objects 16. In another example, the plurality of regions 46 are defined in relation to one single object 16.

Once the region 46 is drawn in relation to the object 16, object parameters 44 corresponding to the region 46 are established. The object parameters 44 that are established include the user-defined time data related to when the region 46 was drawn in relation to the object 16. The user-defined time data may be a particular point in time or duration of time. For example, the authoring tool 34 may record a start time and an end time that the region is drawn 46 in relation to the object 16. The user-defined time data may also include a plurality of different points in time or a plurality of different durations of time. The user-defined positional data is based on the size and position of the region 46 drawn. The position of the object 16 may be determined in relation to various references, such as the perimeter of the field of view of the media content 18, and the like. The region 46 includes vertices that define a closed outline of the region 46. In one embodiment, the user-defined positional data includes coordinate data, such as X-Y coordinate data that is derived from the position of the vertices of the region 46.

The media content 18 may be advanced forward, i.e. played or fast-forwarded, and the attributes of the object 16 may change. In such instances, the object parameters 44 may be re-established in response to changes to the object 16 in the media content 18. The region 46 may be re-defined to accommodate a different size or position of the object 16. Once the region 46 is re-defined, updated object parameters 44 may be established. In one example, object parameters 44 that correspond to an existing region 46 are overwritten by updated object parameters 44 that correspond to the re-defined region 46. In another example, existing object parameters 44 are preserved and used in conjunction with updated object parameters 44. Re-defining the region 46 may be accomplished by clicking and dragging the vertices or edges of the region 46 in the authoring tool 34 to fit the size and location of the object 16.

In one embodiment, the authoring tool 34 provides a data output capturing the object parameters 44 that are established. The data output may include a file that includes code representative of the object parameters 44. The code may be any suitable format for allowing quick parsing through the established object parameters 44. However, the object parameters 44 may be captured according to other suitable methods. It is to be appreciated that the term “file” as used herein is to be understood broadly as any digital resource for storing information, which is available to a computer process and remains available for use after the computer process has finished.

It is important to note that the step 100 of establishing object parameters 44 does not require accessing individual frames of the media content 18. When the region 46 is drawn, individual frames of the media content 18 need not be accessed or manipulated. Instead, the method 12 enables the object parameters 44 to be established easily because the regions 46 are drawn in relation to time and position, rather than individual frames of the media content 18. In other words, the object parameters 44 do not exist for one frame and not the next. So long as the region 46 is drawn for any given time, the object parameters 44 will be established for the given time, irrespective of anything having to do with frames.

At step 102, the object parameters 44 are stored in the database 38. As mentioned above, the object parameters 44 are established and may be outputted as a data output capturing the object parameters 44. The data output from the authoring tool 34 is saved into the database 38. For example, the file having the established object parameters 44 encoded therein may be stored in the database 38 for future reference. In one example as shown in FIG. 1, the object parameters 44 are stored in the database 38 through a chain of communication between the editing device 38, the web server 22, and the media server 36, and the database 38. However, various other chains of communication are possible, without deviation from the scope of the invention.

The method 12 allows for the object parameters 44 to be stored in the database 38 such that the region 46 defined in relation to the object 16 need not be displayed over the object 16 during playback of the media content 18. Thus, the method 12 does not require a layer having a physical region that tracks the object 16 in the media content 18 during playback. The regions 46 that are drawn in relation to the object 16 in the authoring tool 34 exist only temporarily to establish the object parameters 44. Once the object parameters 44 are established and stored in the database 38, the object parameters 44 may be accessed from the database 38 such that the regions 46 as drawn are no longer needed. It is to be understood that the term “store” with respect to the database 38 is broadly contemplated by the present invention. Specifically, the object parameters 44 in the database 38 may be temporarily cached, and the like.

In some instances, the object parameters 44 that are in the database 38 need to be updated. For example, one may desire to re-define the positional data of the region 46 or add more regions 46 in relation to the object 16 using the authoring tool 34. In such instances, the object parameters 44 associated with the re-defined region 46 or newly added regions 46 are stored in the database 38. In one example, the file existing in the database 38 may be accessed and updated or overwritten.

The database 38 is configured to have increasing amounts of object parameters 44 stored therein. Mainly, the database 38 may store the object parameters 44 related to numerous different media content 18 for which object parameters 44 have been established in relation to objects 16 in each different media content 18. In one embodiment, the database 38 stores a separate file for each separate media content 18 such that once a particular media content 18 is presented to the user 20, the respective file having the object parameters 44 for that particular media content 18 can be quickly referenced from the database 38. As such, the database 38 is configured for allowing the object parameters 44 to be efficiently organized for various media content 18.

At step 104, the object parameters 44 are linked to the additional information 14. The additional information 14 may include advertising information, such as brand awareness and/or product placement-type advertising. Additionally, the additional information 14 may be commercially related to the object 16. In one example, as shown in FIG. 3, the additional information 14 is an advertisement commercially related to the clothing item presented in the media content 18. The additional information 14 may be linked to the object parameters 44 according to any suitable means, such as by a link. The additional information 14 may take the form of a uniform resource locator (URL), an image, a creative, and the like.

The additional information 14 may be generated using the authoring tool 34. In one embodiment, as shown in FIG. 2, the authoring tool 34 includes various inputs allowing a user of the editing device 32 to define the additional information 14. For instance, the URL that provides a link to a website related to the object 16 may be inputted in relation to the defined region 46. The URL provides the user 20 viewing the media content 18 access to the website related to the additional information 14 once the user 20 selects the object 16. A description of the additional information 14 or object 16 may also be defined. The description provides the user 20 of the media content 18 with written information related to the additional information 14 once the user 20 selects the object 16. For example, the description may be a brief message explaining the object 16 or a promotion related to the object 16. Additionally, an image, logo, or icon related to the additional information 14 may be defined. The user 20 viewing the media content 18 may be presented with the image related to the additional information 14 once the object 16 is selected by the user 20.

The additional information 14 linked with the object parameters 44 may be stored in the database 38. Once the additional information 14 is defined, the corresponding link, description, and icon may be compiled into a data output from the authoring tool 34. In one embodiment, the data output related to the additional information 14 is provided in conjunction with the object parameters 44. For example, the additional information 14 is encoded in relation to the object parameters 44 that are encoded in the same file. In another example, the additional information 14 may be provided in a different source that may be referenced by the object parameters 44. In either instance, the additional information 14 may be stored in the database 38 along with the object parameters 44. As such, the additional information 14 may be readily accessed without requiring manipulation of the media content 18.

Once the object parameters 44 are established and linked with the additional information 14, the media content 18 is no longer required by the editing device 32, the authoring tool 34, or the media server 36. The media content 18 can be played separately and freely in the player 26 to the user 20 without any intervention by the editing device 32 or authoring tool 34. Generally, the media content 18 is played by the player 26 after the object parameters 44 are established such that the method 12 may reference the established object parameters 44 in response to user 20 interaction with the media content 18.

As mentioned above, the user 20 is able to select the object 16 in the media content 18. When the user 20 selects the object 16 in the media content 18, a selection event is registered. The selection event may be defined as a software-based event whereby the user 20 selects the object 16 in the media content 18. The user device 24 that displays the media content 18 to the user 20 may employ various forms of allowing the user 20 to select the object 16. For example, the selection event may be further defined as a click event, a touch event, voice event or any other suitable event representing the user's 20 intent to select the object 16. The selection event may be registered according to any suitable technique.

At step 106, selection event parameters are received in response to the selection event by the user 20 selecting the object 16 in the media content 18 during playback of the media content 18. It is to be appreciated that the user 20 that selects the object 16 in the media content 18 may be different from the user 20 of the editor. Preferably, the user 20 that selects the object 16 is an end viewer of the media content. The selection event parameters include selection time and selection positional data corresponding to the selection event. The time data may be a particular point in time or duration of time during which the user 20 selected the object 16 in the media content 18. The positional data is based on the position or location of the selection event in the media content 18. In one embodiment, the positional data includes coordinate data, such as X-Y coordinate data that is derived from the position or boundary of the selection event. The positional data of the selection event may be represented by a single X-Y coordinate or a range of X-Y coordinates. It is to be appreciated that the phrase “during playback” does not necessarily mean that the media content 18 must be actively playing in the player 26. In other words, the selection event parameters may be received in response to the user 20 selecting the object 16 when the media content 18 is stopped or paused.

The selection event parameters may be received in response to the user 20 directly selecting the object 16 in the media content 18 without utilizing a layer that is separate from the media content 18. The method 12 advantageously does not require a layer having a physical region that tracks the object 16 in the media content 18 during playback. Accordingly, the selection event parameters may be captured simply by the user 20 selecting the object in the media content 18 and without attaching additional functionality to the media content 18 and/or player 26.

The selection event parameters may be received according to various chains of communication. In one embodiment, as shown in FIG. 1, the selection event occurs when the user 20 selects the object 16 in the player 26 of the user device 24. The selection event parameters corresponding to the selection event are transmitted through the web server 22 to the media server 36. In one embodiment, the selection event parameters are ultimately received at the media server 36. In another embodiment, the selection event parameters are ultimately received at the database 38.

Once the selection event parameters are received, the method 12 may include the step of accessing the object parameters 44 from the database 38 in response to the selection event. In such instances, the method 12 may implicate the object parameters 44 only when a selection event is received. By doing so, the method 12 efficiently processes the selection event parameters without requiring continuous real-time synchronization of between the object parameters 44 in the database 38 and the media content 18. In other words, the method 12 advantageously references the object parameters 44 in the database 38 when needed, thereby minimizing any implications on the user device 24, the player 26, the media server 36, the web server 22, and the media content 18. The method 12 is able to take advantage of the increase in today's computer processing power to reference on-demand the object parameters 44 in the database 38 upon the receipt of selection event parameters from the user device 24.

At step 108, the selection event parameters are compared to the object parameters 44 in the database 38. The method 12 compares the user-defined time and user-defined positional data related to the region 46 defined in relation to the object 16 with the selection positional and selection time data related to the selection event. Comparison between the selection event parameters and the object parameters 44 may occur in the database 38 and/or the media server 36. The selection event parameters may be compared to the object parameters 44 utilizing any suitable means of comparison. For example, the media server 36 may employ a comparison program for comparing the received selection event parameters to the contents of the file having the object parameters 44 encoded therein.

At step 110, the method 12 determines whether the selection event parameters are within the object parameters 44. In one embodiment, the method 12 determines whether the selection time and selection positional data related to selection event parameters correspond to the user-defined time and user-defined positional data related to the region 46 defined in relation to the object 16. For example, the object parameters 44 may have time data defined between 0:30 seconds and 0:40 seconds during which the object 16 is visually present in the media content 18 for a ten-second interval. The object parameters 44 may also have positional data with Cartesian coordinates defining a square having four vertices spaced apart at (0, 0), (0, 10), (10, 0), and (10, 10) during the ten-second interval. If the received selection event parameters register time data between 0:30 seconds and 0:40 seconds, e.g., 0:37 seconds, and positional data within the defined square coordinates of the object parameters 44, e.g., (5, 5), then the selection event parameters are within the object parameters 44. In some embodiments, both time and positional data of the selection event must be within the time and positional data of the object parameters 44. Alternatively, either one of the time or positional data of the selection event parameters need only be within the object parameters 44.

The step 110 of determining whether the selection event parameters are within the object parameters 44 may be implemented according to other methods. For example, in some embodiments, the method 12 determines whether any part of the positional data corresponding to the selection event is within the positional data associated with the object 16 at a given time. In other words, the positional data of the selection event need not be encompassed by the positional data corresponding to the outline of the region 46. In other embodiments, the positional data of the selection event may be within the positional data of the object parameters 44 even where the selection event occurs outside the outline of the region 46. For example, so long as the selection event occurs in the vicinity of the outline of the region 46 but within a predetermined tolerance, the selection event parameters may be deemed within the object parameters 44.

At step 112, the additional information 14 linked to the object parameters 44 is retrieved if the selection event parameters are within the object parameters 44. In one embodiment, the additional information 14 is retrieved from the database 38 by the media server 36. Thereafter, the additional information 14 is provided to web server 22 and ultimately to the user device 24.

The additional information 14 is displayable to the user 20 without interfering with playback of the media content 18. The additional information 14 may become viewable to the user 20 according to any suitable manner. For instance, as shown in FIG. 3, the additional information 14 is viewable at the side of the player 26 such that the view of the media content 18 is unobstructed. Alternatively, the additional information 14 may become viewable directly within the player 26. The additional information 14 may be displayed in at least one of the player 26 of the media content 18 and a window separate from the player 26.

As mentioned above, the additional information 14 may include advertising information related to the object 16. In one example, as shown in FIG. 3, the additional information 14 is displayed without interfering with playback of the media content 18. The additional information 14 includes the icon, description, and link previously defined by the authoring tool 34. Once the user 20 selects the additional information 14, the user 20 may be directed to a website or link having further details regarding the object 16 selected. As such, the method 12 advantageously provides advertising that is uniquely tailored to the desires of the user 20.

The method 12 may include the step of collecting data related to the object 16 selected by the user 20 in the media content 18. The method 12 may be beneficially used for gathering valuable data about the user's preferences. The data related to the object 16 selected may include what object 16 was selected, when an object 16 is selected, and how many times an object 16 is selected. The method 12 may employ any suitable technique for collecting such data. For example, the method 12 may analyze the database 38 and extract data related to object parameters 44, additional information 14 linked to object parameters 44, and recorded selection events made in relation to particular object parameters 44.

The method 12 may further include the step of tracking user 20 preferences based upon the collected data. The method 12 may be utilized to monitor user 20 behavior or habits. The collected data may be analyzed for monitoring which user 20 was viewing and for how long the user 20 viewed the object 16 or the media content 18. The collected data may be referenced for a variety of purposes. For instance, the object parameters 44 may be updated with the additional information 14 that is specifically tailored to the behavior or habits of the user 20 determined through analysis of the collected data related to the user's 20 past selection events.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A computer-implemented method for providing additional information associated with an object visually present in media content in response to selection of the object in the media content by a user, said method comprising the steps of:
establishing object parameters comprising user-defined time and user-defined positional data associated with the object;
storing the object parameters in a database;
linking the object parameters with the additional information;
receiving selection event parameters in response to a selection event by the user selecting the object in the media content during playback of the media content, the selection event parameters comprising selection time and selection positional data corresponding to the selection event;
comparing the selection event parameters to the object parameters in the database;
determining whether the selection event parameters are within the object parameters; and
retrieving the additional information if the selection event parameters are within the object parameters such that the additional information is displayable to the user without interfering with playback of the media content.

2. A computer-implemented method as set forth in claim 1 further including the step of defining a region in relation to the object.

3. A computer-implemented method as set forth in claim 2 wherein the step of establishing object parameters is further defined as establishing object parameters associated with the region defined in relation to the object.

4. A computer-implemented method as set forth in claim 2 wherein the step of storing the object parameters in the database occurs such that the region defined in relation to the object is not displayed over the object during playback of the media content.

5. A computer-implemented method as set forth in claim 2 wherein the object includes attributes comprising media-defined time and media-defined positional data corresponding to the object, wherein the step of defining the region occurs in relation to the attributes of the object.

6. A computer-implemented method as set forth in claim 2 further including the step of re-defining the region in response to changes to the attributes of the object in the media content.

7. A computer-implemented method as set forth in claim 6 further including the step of storing the object parameters associated with the re-defined region in the database.

8. A computer-implemented method as set forth in claim 2 further including the step of defining a plurality of regions in relation to the object.

9. A computer-implemented method as set forth in claim 8 further including the step of storing the object parameters associated with the plurality of regions in the database.

10. A computer-implemented method as set forth in claim 2 wherein the step of defining the region occurs without accessing individual frames of the media content.

11. A computer-implemented method as set forth in claim 2 wherein the step of determining whether the selection event parameters are within the object parameters is further defined as determining whether the selection event parameters are within the object parameters associated with the region.

12. A computer-implemented method as set forth in claim 2 wherein the step of retrieving the additional information is further defined as retrieving the additional information if the selection event parameters are within the object parameters associated with the region.

13. A computer-implemented method as set forth in claim 1 further including the step of re-establishing object parameters in response to changes to the object in the media content.

14. A computer-implemented method as set forth in claim 1 wherein the step of establishing object parameters occurs without accessing individual frames of the media content.

15. A computer-implemented method as set forth in claim 1 further including the step of storing the additional information linked with the object parameters to the database.

16. A computer-implemented method as set forth in claim 1 further including the step of accessing the object parameters from the database in response to the selection event.

17. A computer-implemented method as set forth in claim 1 wherein the step of receiving selection event parameters in response to a selection event occurs by the user directly selecting the object in the media content without utilizing a layer that is separate from the media content.

18. A computer-implemented method as set forth in claim 1 wherein the step of determining whether the selection event parameters are within the object parameters is further defined as determining whether any part of the positional data corresponding to the selection event is within the positional data associated with the object at a given time.

19. A computer-implemented method as set forth in claim 1 wherein the additional information includes advertising information related to the object, wherein the step of retrieving the additional information is further defined as displaying the advertising information to the user.

20. A computer-implemented method as set forth in claim 1 wherein the step of retrieving the additional information is further defined as displaying the additional information in at least one of a player of the media content and a window separate from the player.

21. A computer-implemented method as set forth in claim 1 further including the step of collecting data related to the object selected by the user in the media content.

22. A computer-implemented method as set forth in claim 21 further including the step of tracking user preferences based upon the collected data.

23. A computer-implemented method for providing additional information associated with an object visually present in media content in response to selection of the object in the media content by a user, said method comprising the steps of:
defining a region in relation to the object;
establishing object parameters comprising user-defined time and user-defined positional data corresponding to the region;
storing the object parameters in a database such that the region defined in relation to the object is not displayed over the object during playback of the media content;
linking the object parameters with the additional information;
receiving selection event parameters in response to a selection event by the user directly selecting the object in the media content during playback of the media content without utilizing a layer that is separate from the media content, the selection event parameters comprising selection time and selection positional data corresponding to the selection event;
accessing the object parameters from the database in response to the selection event;
comparing the selection event parameters to the object parameters in the database;
determining whether the selection event parameters are within the object parameters corresponding to the region; and
retrieving the additional information if the selection event parameters are within the object parameters such that the additional information is displayable to the user without interfering with playback of the media content.
